(19) United States
(12) Patent Application Publication
(10) Pub. No.: US 2010/0079912 A1
(43) Pub. Date: Apr. 1, 2010

(54) MAGNETIC RECORDING DEVICE AND MAGNETIC RECORDING METHOD

(75) Inventors: Hiroyuki Hama, Kawasaki (JP); Masahiko Miyake, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/512,790

(22) Filed: Jul. 30, 2009

(30) Foreign Application Priority Data
Sep. 26, 2008 (JP) 2008-247635

(51) Int. Cl. G11B 5/325

(52) U.S. Cl. 360/118; G9B/5.061

(57) ABSTRACT

A magnetic recording device includes a write head, a perpendicular magnetic recording medium, a recording-current generating circuit, and a setting circuit. The perpendicular magnetic recording medium includes a plurality of tracks that includes a recording track. The recording-current generating circuit generates a recording electric current. The write head supplied with the recording current writes a recording data pattern on the recording track. The setting circuit sets a value of the recording electric current such that the value of the recording electric current decreases as a magnitude of side erase effect on at least one track of the tracks adjacent to the recording track increases.

### CROSS-REFERENCE TO RELATED APPLICATION

This application is based upon and claims the benefit of priority of the prior Japanese Patent Application No. 2008-247635, filed on Sep. 26, 2008, the entire contents of which are incorporated herein by reference.

### FIELD

The embodiments discussed herein are directed to a magnetic recording device and a magnetic recording method.

### BACKGROUND

Hard disk drives have been used as information storage devices for various information processing apparatuses. In recent years, data storage devices having a larger capacity and capable of writing/reading data at higher recording density have been eagerly demanded.

This demand can be satisfied by employment of a small bit length. However, using a small bit length in a conventional longitudinal magnetic recording system exacerbates adverse influences of thermal decay. To this end, research and development of perpendicular magnetic recording systems that record data by magnetizing a magnetic recording medium in a direction perpendicular to a recording surface of the medium have been actively carried out.

The recording density can be increased by increasing any one of a linear recording density, which is a density in a circumferential direction (or recording track direction) of a disk, and a track density, which is a radial direction of the disk. The track density can be increased by reducing the width of the data track and/or a track pitch. However, when at least one of a value of recording electric current (hereinafter, “recording (writing) current value”) and a value of overshoot electric current (hereinafter, “overshoot current value”) is increased at a uniform ratio, the recording track width is widened, which increases the magnitude of an effect on adjacent tracks (side erase effect). Hence, it is difficult to increase the track density through this approach. Decreasing at least one of the recording current and the overshoot current at a uniform ratio leads to degradation in read/write performance. Hence, it is also difficult to increase the linear recording density through this approach.

At least one of the recording current and the overshoot current can be increased or decreased by, for example, setting the recording current such that the longer the recording wavelength, the lower the recording current, and vice versa in a longitudinal magnetic recording system so as to minimize an adverse effect of crosstalk between adjacent tracks. Alternatively, at least one of the recording current and the overshoot current can be changed so as to compensate non-linear transition shift (NLTS). Examples of these approaches are disclosed in Japanese Laid-open Patent Publication No. 11-144205, Japanese Laid-open Patent Publication No. 01-227201, Japanese Laid-open Patent Publication No. 11-203608, and Japanese Laid-open Patent Publication No. 2008-41159.

In a perpendicular magnetic recording system, frequency dependence of side erase effect on a recording frequency varies depending on a combination of components, such as a write head, a recording medium, an IC for the head, and a read/write channel, of a magnetic recording device. More specifically, frequency dependence of the side erase effect of a perpendicular magnetic recording device is substantially divided into two types. In a first type of the two types, the magnitude of the side erase effect increases as the recording frequency increases while in a second type of the two types, the magnitude of the side erase effect increases as the recording frequency decreases. In the above conventional techniques, the recording current value is set such that the shorter the recording wavelength; i.e., the higher the recording frequency, the higher the recording current value while the longer the recording wavelength; i.e., the lower the recording frequency, the lower the recording current value. Accordingly, this technique fails to reduce the side erase effect of a magnetic recording device of the first type, thereby failing to attain high-density recording.

### SUMMARY

According to an aspect of an embodiment of the invention, a magnetic recording device includes a write head; a perpendicular magnetic recording medium that includes a plurality of tracks, the tracks including a recording track; a recording-current generating circuit that generates a recording electric current that is to be supplied to the write head for writing of a recording data pattern on the recording track of the perpendicular magnetic recording medium; and a setting circuit that sets a value of the recording electric current such that the value of the recording electric current decreases as magnitude of side erase effect on one track of the tracks other than the recording track increases, the side erase effect being caused by the writing of the recording data pattern on the recording track.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic plan view of a magnetic recording device according to an embodiment;

FIG. 2 is a schematic enlarged cross-sectional perspective view of a read/write head and a recording medium;

FIG. 3 is a block diagram of a circuit configuration of the magnetic recording device of the present embodiment;

FIGS. 4A to 4C are waveform charts for explaining recording currents;

FIG. 5 is a schematic view of a plurality of tracks on the recording medium;

FIGS. 6A and 6B are examples of graphs that illustrate relation between recording frequencies and error rate differences;

FIGS. 7A and 7B are schematic views of a plurality of tracks on the recording medium;

FIG. 8 is an example of a graph that illustrates relation between track pitches and read output ratios;

FIGS. 9A and 9B are examples of graphs that illustrate relation between recording frequencies and erase widths;

FIG. 10 is a schematic chart of an example of a recording data pattern;

FIG. 11 is an example of a reference table that presents relation between recording/overshoot current values and bit transition intervals;

FIG. 12 is a flowchart for setting a recording-current based on a bit transition interval;

FIG. 13 is a schematic chart of an example of the recording data pattern;

FIG. 14 is an example of a reference table that presents relation between recording/overshoot current values and bit transition intervals;

FIG. 15 is a block diagram of a circuit configuration of another magnetic recording device according to the present embodiment;

FIG. 16A is an example of a reference table to be referred to by a recording compensating circuit depicted in FIG. 3;

FIG. 16B is a schematic view that illustrates an example in which a bit transition interval is shifted by compensation;

FIG. 17 is an example of a reference table to be referred to by a dual-purpose setting circuit; and

FIG. 18 is a flowchart for setting a recording current value based on a bit string.

### DESCRIPTION OF EMBODIMENTS

Preferred embodiment of the present invention will be explained with reference to accompanying drawings.

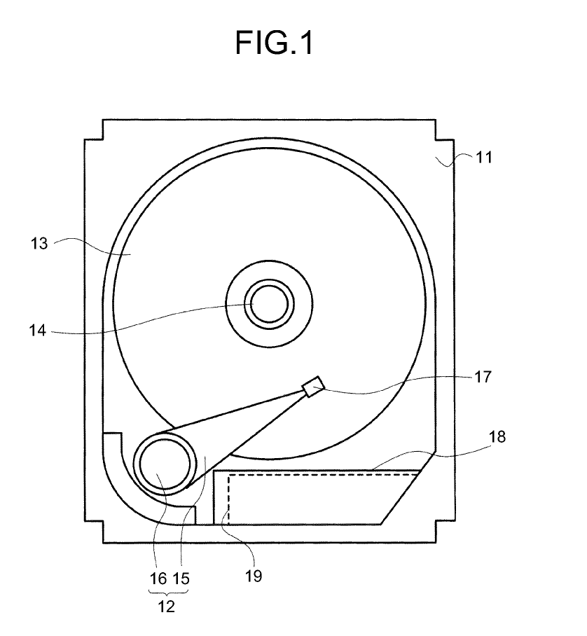

The configuration of the magnetic recording device according to an embodiment will be described with reference to FIGS. 1 to 3.

FIG. 1 is a schematic plan view depicting the configuration of the magnetic recording device of the present embodiment.

The magnetic recording device employs a perpendicular magnetic recording system. The magnetic recording device includes a casing 11, an actuator 12, a disk-shaped recording medium 13, a spindle motor 14, a circuit board 18, and a package board 19. The actuator 12, the recording medium 13, the spindle motor 14, and the circuit board 18 are arranged inside the casing 11. The package board 19 is arranged on the back surface of the casing 11.

The spindle motor 14 drives the recording medium 13 to spin. The actuator 12 includes an arm 15 and a voice coil motor (VCM) 16. A read/write head 17 is mounted on the arm 15. The VCM 16 moves the arm 15 above and across the radius of the recording medium 13. The circuit board 18 includes a preamplifier circuit. The preamplifier circuit generates a recording current and amplifies a reproduced electric signal. The preamplifier circuit is connected with the read/write head 17 by way of a flexible printed circuit cable (FPC) through which read/write signals are transferred to and from the read/write head 17. An interface circuit for connecting with a host device, a hard disk controller (HDC), a read/write channel LSI (large-scale integrated circuit) (hereinafter, “R/W channel”), and the like are packaged on a package board 19. The package board 19 and the circuit board 18 are electrically connected together for signal transmission.

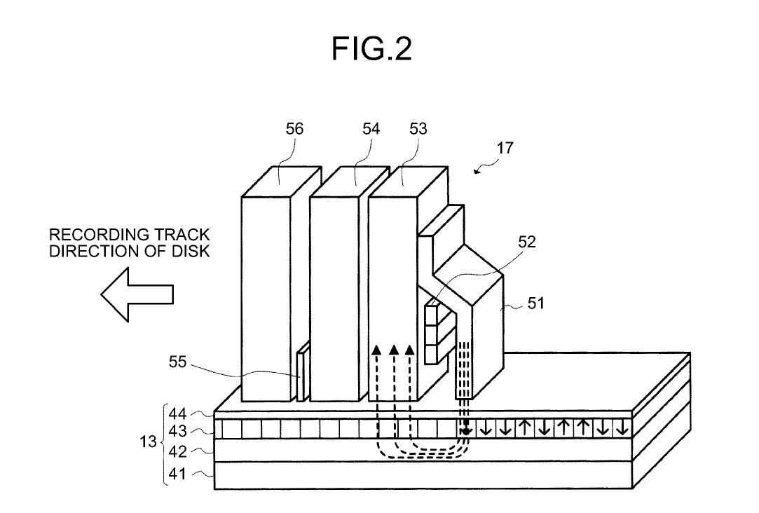

FIG. 2 is a schematic enlarged cross-sectional perspective view of the read/write head 17 and the recording medium 13.

As depicted in FIG. 2, the recording medium 13, which is a perpendicular magnetic recording medium, includes a substrate 41, a soft magnetic layer 42, a magnetic recording layer 43, and a surface protection layer 44. The substrate 41 is made of glass, aluminum, or the like. The soft magnetic layer 42 is a layer of a CoTaZr alloy or the like deposited on the surface of the substrate 41. The magnetic recording layer 43 is a layer of a CoCrPt alloy or the like deposited on the surface of the soft magnetic layer 42. The surface protection layer 44 covers the surface of the magnetic recording layer 43.

The read/write head 17, depicted in FIG. 2, includes a single-pole type magnetic recording head that is typically employed in a perpendicular magnetic recording system. The read/write head 17 includes a main pole 51, a magnetizing coil 52, an auxiliary magnetic pole 53, a magnetic-field sensing element 55, and magnetic-field shields 54 and 56.

To perform data writing, an electric current is supplied to the magnetizing coil 52, which in turn magnetizes the main pole 51. The magnetized main pole 51 produces a magnetic field. Flux lines of the magnetic field produced by the main pole 51 flow, as depicted by dotted lines in FIG. 2, through the magnetic recording layer 43 and the soft magnetic layer 42 and return to the auxiliary magnetic pole 53. Hence, the flux lines form a closed magnetic circuit. By applying the magnetic field directed from the main pole 51 to the auxiliary magnetic pole 53 to the recording medium 13, data is written on the recording medium 13 as indicated by solid lines in the magnetic recording layer 43. Data reproduction is performed by the magnetic-field sensing element 55, such as a magnetoresistive (MR) element. The magnetic-field sensing element 55 detects flux leakage from the magnetic recording layer 43 of the recording medium 13 to read the written data as magnetoresistance. The magnetic-field shields 54 and 56 block a magnetic flux flowing from other magnetic domains than a target magnetic domain, from which data is to be read, thereby increasing reproduction sensitivity of the read/write head 17.

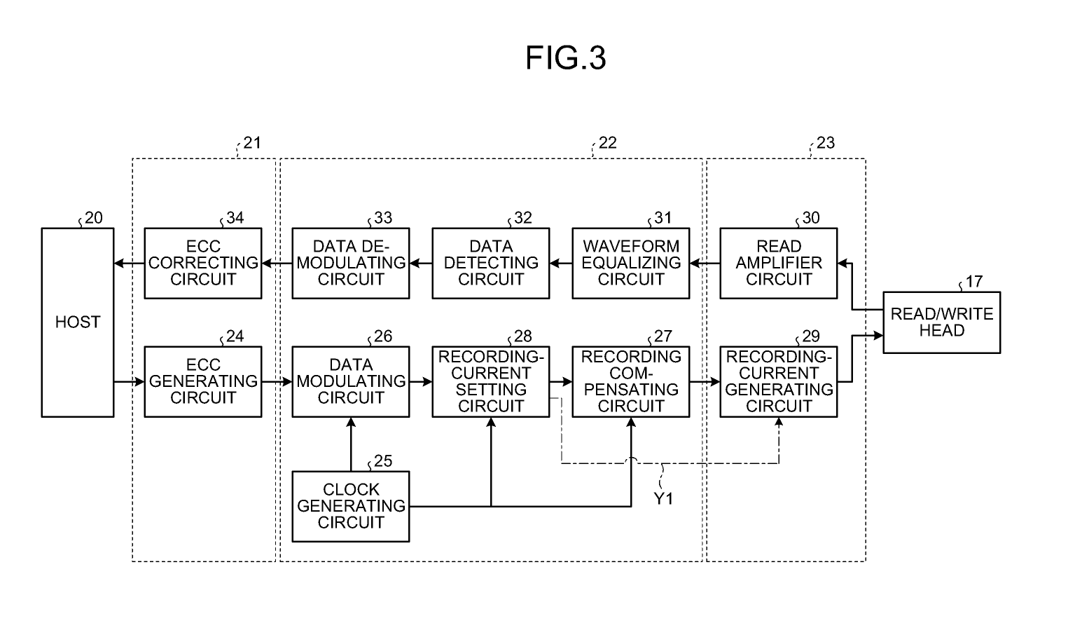

FIG. 3 is a block diagram of an example of a configuration of a control circuit (including an HDC 21, an R/W channel 22, and a preamplifier circuit 23) of the magnetic recording device.

The HDC 21 includes an error correction code (ECC) generating circuit 24 for use in data writing and an ECC correcting circuit 34 for use in data reading.

The R/W channel 22 includes, as circuits for use in data writing, a clock generating circuit 25, a data modulating circuit (encoder) 26, a recording compensating circuit (write pre-compensation circuit) 27, and a recording-current setting circuit 28. The R/W channel 22 includes, as circuits for use in data reading, a waveform equalizing circuit 31, a data detecting circuit 32, and a data demodulating circuit (decoder) 33.

The preamplifier circuit 23 includes a recording-current generating circuit 29 for use in data writing and a read amplifier circuit 30 for use in data reading.

How the magnetic recording device writes data (hereinafter, “recording data”) that is fed from a host device 20 to be written on the recording medium 13 will be described. The ECC generating circuit 24 in the HDC 21 appends an error correcting code to the recording data. The recording data is fed to the R/W channel 22 where the recording data is processed in synchronization with a clock signal generated by the clock generating circuit 25. The recording data is modulated by the data modulating circuit 26 into such a recording data pattern that has small amount of data errors when reproduced. The modulated recording data is fed to the recording-current setting circuit 28. The recording-current setting circuit 28 sets a value of a recording electric current (hereinafter, “recording current value”) according to the recording data pattern so as to counteract side erase effect on a track adjacent to a recording track, which will be described later in detail. The recording-current setting circuit 28 transmits a control signal responsive to the recording current value to the recording-current generating circuit 29 as indicated by an alternate long and short dash line arrow Y1 in FIG. 3, while the recording-current setting circuit 28 transmits the recording data pattern to the recording compensating circuit 27. The recording data pattern is subjected to non-linear transition shift (NLTS) compensation performed by the recording compensating circuit 27.

The NLTS compensation will be described briefly. NLTS is generally a phenomenon in which a demagnetizing field derived from preceding magnetization strengthens or weakens a recording magnetic field (the magnetic field produced by the read/write head 17), thereby shifting a magnetization transition position from an aimed position forward or backward. In a perpendicular magnetic recording system, NLTS occurs such that preceding magnetization at an adjacent magnetic domain causes a magnetization transition position to shift backward relative to an aimed position, which eventually increases a bit length. When data is written without performing any compensation for such NLTS, reproduced data of the thus-written data can have a significant error rate. To this end, the recording compensating circuit 27 performs compensation for the NLTS by shifting the magnetization transition position in the recording data pattern forward in advance so as to reduce the bit length on the recording medium 13. The NLTS compensation will be described in detail later.

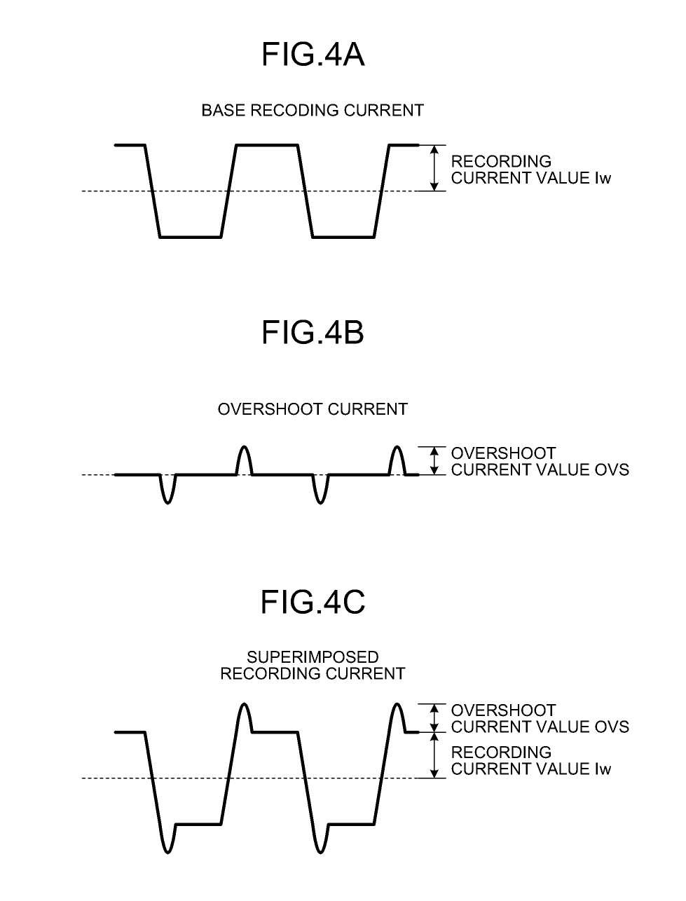

The recording data pattern having been subjected to the NLTS compensation in the recording compensating circuit 27 is then fed to the recording-current generating circuit 29 in the preamplifier circuit 23. The recording-current generating circuit 29 generates a recording current according to the recording data pattern. FIGS. 4A to 4C are examples of waveform charts of the recording currents. Generally, a recording current depicted in FIG. 4C has a waveform obtained by superimposing an overshoot current (as depicted in FIG. 4B) that has a wave-like pulse shape on rising edges of a base recording current (as depicted in FIG. 4A) that has a rectangular pulse shape. How the recording-current generating circuit 29 basically generates the recording current will be described. The recording-current generating circuit 29 sets each of Iw, which is a value of the base recording current, and OVS, which is a value of the overshoot current, to a fixed value according to the recording data pattern fed from the recording compensating circuit 27. The recording-current generating circuit 29 superimposes the overshoot current whose amplitude is the overshoot current value OVS on the base recording current whose amplitude is the recording current value Iw.

Meanwhile, if an electric current value has been set by the recording-current setting circuit 28, the recording-current generating circuit 29 generates a recording current based on this current value. For example, if the recording current value Iw has been set by the recording-current setting circuit 28, the recording-current generating circuit 29 generates a base recording current having a rectangular pulse shape whose amplitude is the recording current value Iw. If the overshoot current value OVS has been set by the recording-current setting circuit 28, the recording-current generating circuit 29 generates an overshoot current having a wave-like pulse shape whose amplitude is the over shoot current value OVS.

Referring to FIG. 3, the recording-current generating circuit 29 supplies the recording current that is generated by superimposing the overshoot current on the base recording current to the magnetizing coil 52 of the read/write head 17. The recording current that flows through the magnetizing coil 52 of the read/write head 17 causes a magnetic field to vary according to the recording current. Hence, the recording data pattern is written on the recording medium 13. How the magnetic recording device operates to write data to the recording medium 13 has hitherto been described.

How data is read from the recording medium 13 will be described. The magnetic-field sensing element 55 of the read/write head 17 detects flux leakage from the magnetic recording layer 43 of the recording medium 13 as magnetoresistance. A waveform of the magnetorsesistance, which corresponds to a reproduced waveform, is sent to the waveform equalizing circuit 31 and the data detecting circuit 32 in the R/W channel 22 by way of the read amplifier circuit 30 in the preamplifier circuit 23. The combination of the waveform equalizing circuit 31 and the data detecting circuit 32 is known as a partial-response maximum-likelihood (PRML) circuit. The PRML circuit equalizes the read waveform into a waveform of a desired property by using a filter, or the like, and thereafter detects data by using a maximum likelihood method. The detected data is fed to the data demodulating circuit 33 to undergo the reverse of the processing performed by the data modulating circuit 26. After being fed to the ECC correcting circuit 34 for detection and correction of data errors, the detected data is returned to the host device 20. The host device 20 reads the data written on the recording medium 13 in this manner. How the magnetic recording device reads data from the recording medium 13 has hitherto been described.

Writing the recording data pattern on the recording medium 13 can cause side erase effect, which is unintended erasure of data written on one or more tracks adjacent to a recording track. To this end, the recording-current setting circuit 28 sets at least one of the recording current value Iw and the overshoot current value OVS so as to counteract the side erase effect on the adjacent tracks. Meanwhile, the side erase effect refers to a phenomenon in which data writing on a target track unintentionally erases a portion of data that has already been written on one or more tracks adjacent to or near the target track.

More specifically, the recording-current setting circuit 28 sets at least one of the recording current value Iw and the overshoot current value OVS (hereinafter, “recording/overshoot current value Iw/OVS”) such that the greater magnitude of the side erase effect corresponding to the recording data pattern, the lower the recording/overshoot current value Iw/OVS by referring to predetermined data about relation between recording data patterns and magnitudes of the side erase effect on one or more tracks adjacent to the recording track. By setting the recording/overshoot current value Iw/OVS in this manner (this recording current setting includes a setting for both of the recording current value Iw and the overshoot current value OVS), the magnitude of the side erase effect on the adjacent tracks can be reduced while maintaining favorable read/write characteristics as compared with an approach that sets the recording/overshoot current value Iw/OVS depending on only the recording frequency. Hence, high-density recording can be attained.

Meanwhile, the recording-current setting circuit 28 sets the recording current value according to the recording data pattern having been modulated by the data modulating circuit 26. This is because the data that is to be actually written on the recording medium 13 is the recording data pattern having been modulated by the data modulating circuit 26. The recording-current setting circuit 28 sets the recording current value before the recording compensating circuit 27 compensates the shifting of a magnetization transition position of the recording data pattern. Put another way, the recording compensating circuit 27 performs the NLTS compensation for the recording data pattern for which the recording/overshoot current value Iw/OVS has been set by the recording-current setting circuit 28. This is because the data that is to be actually written on the recording medium 13 is the recording data pattern that is not subjected to the NLTS compensation performed by the recording compensating circuit 27 yet. By setting the recording current value according to the recording data pattern that is to be actually written on the recording medium 13, the side erase effect can be effectively reduced. Because the NLTS changes as the recording/overshoot current value Iw/OVS changes, it is preferable to perform the NLTS compensation depending on the recording/overshoot current value Iw/OVS.

How the recording-current setting circuit 28 sets the recording current will be described in detail below.

As an example of a method for setting the recording current value, a recording-current setting method based on a bit transition interval between magnetization transitions (hereinafter, “bit transition interval”) will be described. According to the method for setting the recording current value based on the bit transition interval, the bit transition interval of the recording data pattern is detected. A recording-current setting processing based on the bit transition interval sets the recording/overshoot current value Iw/OVS such that the greater the magnitude of side erase effect that depends on the detected bit transition interval, the lower the recording/overshoot current value Iw/OVS by referring to predetermined data about relation between bit transition intervals and magnitudes of the side erase effect.

The relation between the bit transition interval and the magnitude of the side erase effect can be obtained by, for example, determining a property of the side erase effect as to how the magnitude of the side erase effect changes in response to a change in recording frequency (frequency dependence of the side erase effect).

The frequency dependence of the side erase effect is, more specifically, a property of the side erase effect as to whether the magnitude of the side erase effect on adjacent tracks increases as the recording frequency increases or the magnitude increases as the recording frequency decreases. The frequency dependence can be determined in advance by performing experiments or the like. The frequency dependence of side erase effect of a perpendicular magnetic recording device varies depending on a combination of components, such as a write head, a recording medium, a head IC, a read/write channel, and the like, of the magnetic recording device.

Examples of an index that indicates the magnitude of side erase effect on tracks adjacent to a recording track include a side erase amount and an erasing width. The side erase amount denotes an amount of data that is to be erased from tracks adjacent to or near a recording track when a recording data pattern is written on the recording track. The erase width denotes a width of an area in the track width direction where data is to be erased when the recording data pattern is written on the recording track. The magnitude of the side erase effect on the adjacent tracks increases as each of the side erase amount and the erase width increases, making it more difficult to read written data from the adjacent tracks having undergone the side erase effect. In contrast, the magnitude of the side erase effect on the adjacent tracks decreases as each of the side erase amount and the erase width decreases. As is obvious from this, the frequency dependence of side erase effect can be determined by determining how the side erase amount or the erase width changes in response to a change in recording frequency.

A method for determining the frequency dependence of the side erase effect will be specifically described below.

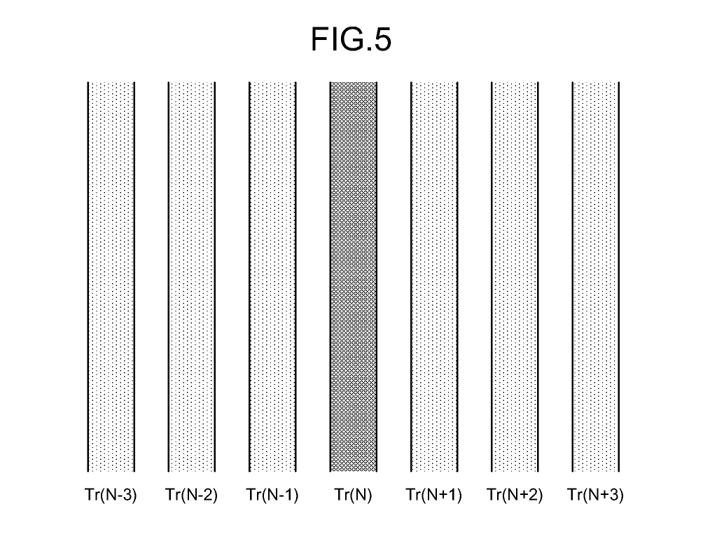

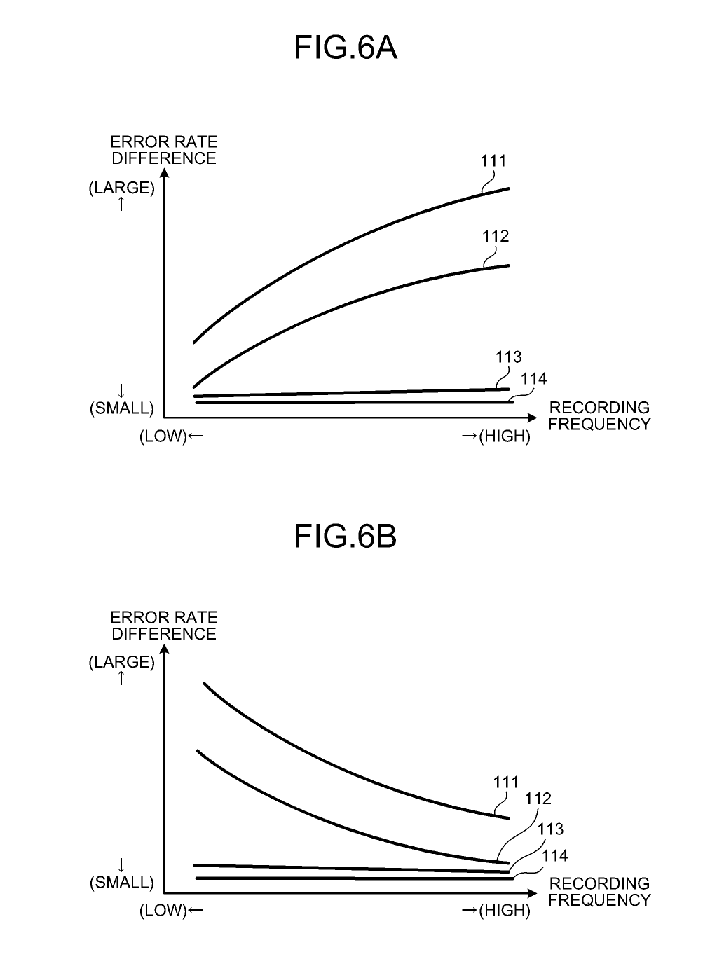

As an example of the method for determining the frequency dependence of the side erase effect, determining how the side erase amount of each of one or more continuous tracks adjacent to a recording track changes in response to a change in recording frequency (side-erase amount determining method) will be described with reference to FIGS. 5 to 6B.

FIG. 5 is a schematic view of an example of a plurality of tracks on the recording medium 13. Seven tracks are depicted in FIG. 5. More specifically, a recording track Tr(N), a plurality of first adjacent tracks Tr(N−3) to Tr(N−1), which are on one side of the recording track Tr(N), and a plurality of second adjacent tracks Tr(N+3) to Tr(N+1), which are on the other side of the recording track Tr(N), are depicted in FIG. 5.

To determine the frequency dependence of the side erase effect, how the side erase amount of each of the first and second adjacent tracks Tr(N−3) to Tr(N−1) and Tr(N+3) to Tr(N+1) changes in response to a change in the recording frequency is determined. The recording frequency is a frequency at which data is to be written on the track Tr(N). An example in which a rate of errors that occur during data reading is used as an example of the index of the side erase amount will be described below; however, the index is not limited to the error rate. Alternatively, an output ratio or a signal-to-noise ratio (S/N) can be used as the index.

More specifically, operational steps (1) to (6) mentioned below are performed to determine the side erase amount.

(1) An arbitrary recording data pattern is written on the tracks Tr(N−3) through Tr(N+3), the tracks Tr(N−3) through Tr(N−1) or the tracks Tr(N+1) through Tr(N+3).

(2) The recording data pattern written on the tracks Tr(N−3) through Tr(N−1) and the tracks (N+1) through Tr(N+3) is read. By reading the recording data pattern, an error rate ERbef of the read data pattern is determined for each of the tracks.

(3) Data writing on the recording track Tr(N) is performed a plurality of times by applying a recording current at a predetermined frequency.

(4) The recording data pattern written on the tracks Tr(N−3) through Tr(N−1) and the tracks (N+1) through Tr(N+3) is read again. By reading the recording data pattern, an error rate ERaft of the read data pattern is determined for each of the tracks.

(5) A difference in the error rates (hereinafter, “error rate difference”) ERaft−ERbef is calculated from the error rate ERbef, which is the error rate before the plurality of data writing is performed on the recording track Tr(N) by applying the recording current at the predetermined frequency, and the error rate ERaft, which is the error rate after the plurality of data writing is performed on the recording track Tr(N).

(6) The recording frequency is varied for each of the recording operations with respect to the track Tr(N). The operational steps (1) through (5) are performed for each of different recording frequencies to obtain the error rate difference ERaft−ERbef of each of the tracks Tr(N−3) through Tr(N−1) and the tracks Tr(N+1) through Tr(N+3).

The error rate difference ERaft−ERbef of each of the tracks Tr(N−3) through Tr(N−1) and the tracks Tr(N+1) through Tr(N+3) can be obtained by performing the above operational steps (1) through (6).

FIGS. 6A and 6B are examples of graphs that present relation between the recording frequencies at which the recording data pattern is to be written on the track Tr(N) and the error rate differences. In FIGS. 6A and 6B, reference numeral 111 indicates a plot of the track Tr(N+1), 112 indicates a plot of the track Tr(N−1), 113 indicates a plot of the track Tr(N−2) and the track Tr(N+2), and 114 indicates a plot of the track Tr(N−3) and the track Tr(N+3).

When a plot that demonstrates relation between the recording frequencies and the error rate differences has a graph as depicted in FIG. 6A, the error rate difference, which corresponds to the side erase amount, of each of one or more continuous tracks adjacent to a recording track increases as the recording frequency for the recording track increases. In this case, the magnitude of the side erase effect on each of the continuous tracks adjacent to the recording track increases as the recording frequency increases.

In contrast, when the plot that demonstrates relation between the recording frequencies and the error rate differences has a graph as depicted in FIG. 6B, the error rate difference, which corresponds to the side erase amount, of each of one or more continuous tracks adjacent to the recording track increases as the recording frequency for the recording track decreases. In this case, the magnitude of the side erase effect on each of the continuous tracks adjacent to the recording track increases as the recording frequency decreases.

How the magnitude of side erase effect on each of continuous tracks adjacent to a recording track changes in response to a change in recording frequency at which a recording data pattern is to be written can be determined in this manner.

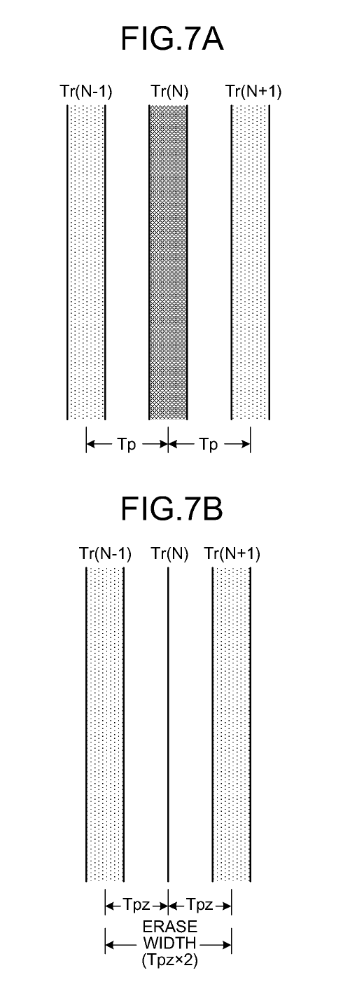

Next, as another example of the method for determining the frequency dependence of the side erase effect, determining how the erase width changes in response to a change in the recording frequency (erase-width determining method) will be described with reference to FIGS. 7A to 9B.

FIGS. 7A and 7B depict three tracks on the recording medium 13 referred to as the recording track Tr(N), the first adjacent track Tr(N−1) adjacent to the recording track Tr(N) on the one side, and the second adjacent track Tr(N+1) adjacent to the recording track Tr(N) on the other side.

Operational steps (1) to (6) are performed to determine the erase width.

(1) An arbitrary recording data pattern is written on the recording track Tr(N) that is positioned between the first and second adjacent tracks Tr(N−1) and Tr(N+1).

(2) Data writing on the first and second adjacent tracks Tr(N−1) and Tr(N+1) is performed at a same frequency. The first and second adjacent tracks Tr(N−1) and Tr(N+1) have a same track pitch Tp relative to the track Tr(N).

(3) The recording data pattern written on the track Tr(N) is read.

(4) The operational steps (1) through (3) are repeated after narrowing the track pitch Tp than that employed in an immediately preceding sequence of (1) to (3). A threshold track pitch Tpz, which is a track pitch with which the recording data pattern written on the track Tr(N) is completely erased and unreadable as depicted in FIG. 7B, is determined.

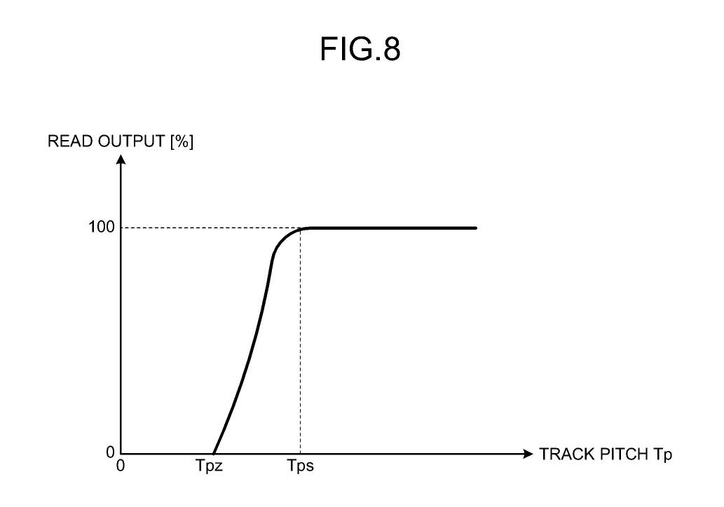

FIG. 8 is an example of a graph that presents relation between the track pitches and read output. As depicted in FIG. 8, when the track pitch Tp is equal to or greater than the threshold track pitch Tps, the read output of the written recording data pattern on the track Tr(N) reaches 100%, indicating that the written recording data pattern on the track Tr(N) is fully read out. However, the track pitch Tp decreases as the steps (1) through (4) are repeatedly performed as mentioned previously. The read output of the recording data pattern written on the track Tr(N) gradually decreases with the decreasing track pitch Tp under the side erase effect that occurs when data is written on the first and second adjacent tracks Tr(N+1) and Tr(N−1). The threshold track pitch Tpz is a track pitch at which the read output reaches 0. The erase width is obtained as a doubled value of the threshold track pitch Tpz.

(5) Next, the operational steps (1) through (4) are performed to write data on the first and second adjacent tracks Tr(N+1) and Tr(N−1) by applying different recording frequencies as depicted in FIGS. 7A and 7B, thereby obtaining erase widths on a frequency-by-frequency basis.

How the erase width changes in response to a change in the recording frequency, at which data writing on the first and second adjacent tracks Tr(N−1) and Tr(N+1) is to be performed, can be determined by performing the operational steps (1) through (5) in this manner.

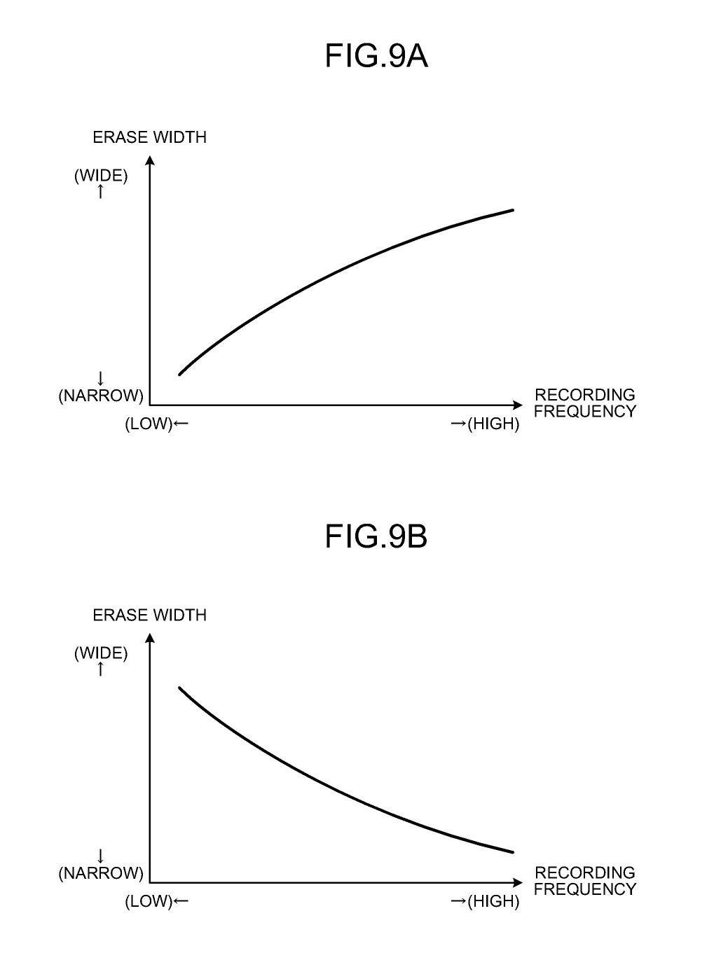

FIGS. 9A and 9B are examples of graphs that present relations between the recording frequencies and the erase widths. When a plot that demonstrates the relation between the recording frequencies and the erase widths has a graph as depicted in FIG. 9A, the erase width, which corresponds to the magnitude of the side erase effect, increases as the recording frequency increases. In contrast, when a plot that demonstrates relation between the recording frequencies and the erase widths has a graph as depicted in FIG. 9B, the erase width, which corresponds to the magnitude of the side erase effect, increases as the recording frequency decreases.

How the magnitude of side erase effect on tracks adjacent to a recording track changes in response to a change in recording frequency at which a recording data pattern is to be written can be determined in this manner.

A selection as to which one of the side-erase amount determining method and the erase width determining method is to be employed will be described. When it is desired to accurately determine a degree of dependence of the side erase effect on the frequency, the side-erase amount determining method is preferably employed. This is because, in a perpendicular magnetic recording system, side erase effect that occurs when a recording data pattern is written on a recording track affects not only tracks adjacent to the recording track but also other tracks that are farther away from the recording tracks than the adjacent tracks in some cases. For example, in a perpendicular magnetic recording system, writing a recording data pattern on a recording track causes such a phenomenon in some cases that even though a recording data pattern on a track adjacent to the recording track is not erased, a recording data pattern on other tracks farther away from the recording track than the adjacent track is erased. In other some cases, writing a recording data pattern on a recording track results in simultaneous erasure of written recording data patterns from a plurality of tracks adjacent to the recording track.

However, even for such cases, frequency dependence of the side erase effect can be determined relatively accurately by employing the side-erase amount determining method. This is because not only the magnitude of the side erase effect on the adjacent tracks but also the magnitude of the side erase effect on other tracks farther away from the recording track than the adjacent tracks is determined in the side-erase amount determining method. Meanwhile, the erase width determining method is advantageous in that the frequency dependence of the side erase effect can be determined in a shorter period of time than that by using the side-erase amount determining method.

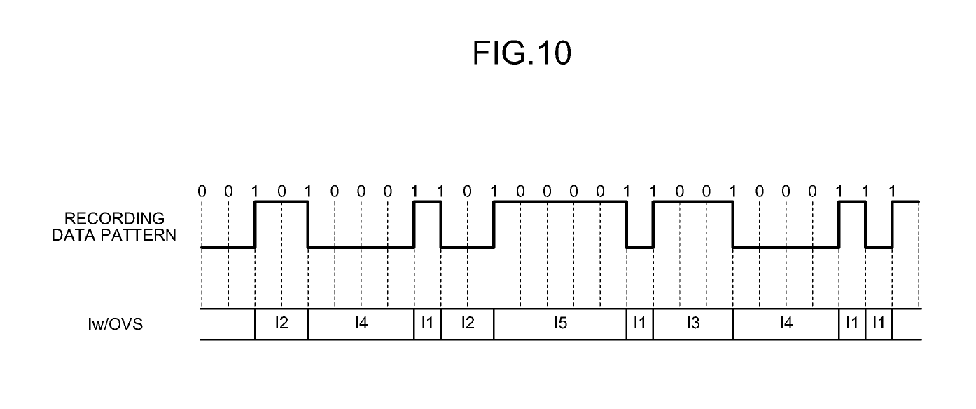

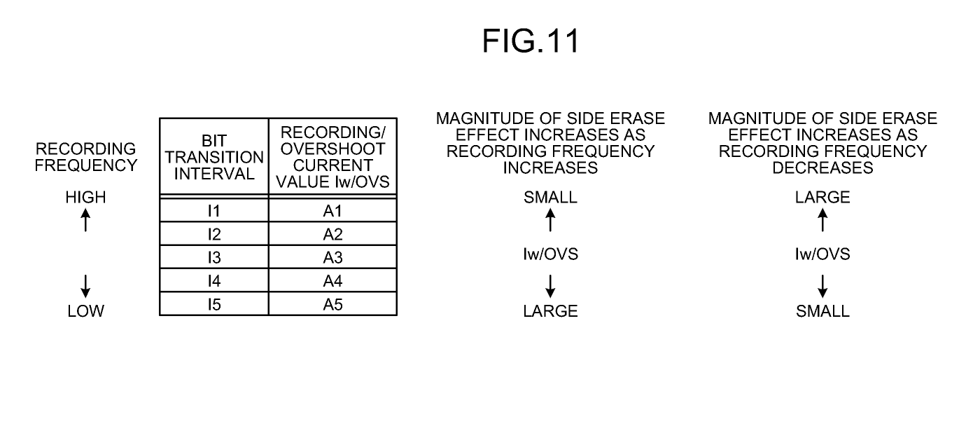

Next, how to set the recording current will be specifically described with reference to FIGS. 10 and 11. As mentioned previously, according to the recording current setting method based on the bit transition interval, the recording-current setting circuit 28 sets the recording/overshoot current value Iw/OVS to a value that corresponds to the detected bit transition interval by referring to the predetermined data about relation between bit transition intervals and magnitudes of the side erase effect.

FIG. 10 is a schematic chart of an example of the recording data pattern. Each of reference numerals and symbol I1 to I5 on a bottom portion of FIG. 10 is an identification symbol that indicates a bit transition interval of the recording data pattern. The greater the numeral of the identification symbols I1 to I5, the longer the bit transition interval is. The recording-current setting circuit 28 detects the bit transition interval of the recording data pattern modulated by the data modulating circuit 26 by using the clock signal generated by the clock generating circuit 25.

The recording-current setting circuit 28 refers to a reference table that presents relation between the recording/overshoot current values Iw/OVS and the bit transition intervals and sets the recording/overshoot current value Iw/OVS to a value that corresponds to the obtained bit transition interval in the reference table. FIG. 11 is an example of the reference table that presents the relation between the recording/overshoot current values Iw/OVS and the bit transition intervals. In FIG. 11, A1 to A5 are set as the recording/overshoot current values Iw/OVS that correspond to the bit transition intervals I1 to I5, respectively. According to this reference table, for example, when I2 is obtained as the bit transition interval, the recording-current setting circuit 28 sets the recording/overshoot current value Iw/OVS to A2.

The values A1 to A5 are set based on the frequency dependence of the side erase effect that has already been determined. For example, A1 to A5 are set based on such data as depicted in FIGS. 6A and 6B about relation between the recording frequency and the error rate difference or on such as depicted in FIG. 9 about relation between the recording frequency and the erase width.

Generally, the greater the bit transition interval, the lower the recording frequency, and vice versa. Accordingly, when the side erase effect exhibits such a frequency dependence that the higher the recording frequency, the greater the magnitude of the side erase effect, it is expected that the smaller the bit transition interval, the greater the magnitude of the side erase effect. Hence, in this case, the recording/overshoot current values Iw/OVS in the reference table are set to satisfy A5>A4>A3>A2>A1. Put another way, the reference table is set such that the smaller the bit transition interval, the lower the recording/overshoot current value Iw/OVS that corresponds to the bit transition interval.

In contrast, when the side erase effect exhibits such a frequency dependence that the lower the recording frequency, the greater the magnitude of the side erase effect, it is expected that the greater the bit transition interval, the greater the magnitude of the side erase effect. Hence, in this case, the recording/overshoot current values Iw/OVS in the reference table are set so as to satisfy A1>A2>A3>A4>A5. Put another way, the reference table is such that the greater the bit transition interval, the lower the recording/overshoot current value Iw/OVS that corresponds to the bit transition interval.

In short, the recording-current setting circuit 28 sets the recording/overshoot current value Iw/OVS such that the greater the magnitude of the side erase effect that depends on the bit transition interval, the lower the recording/overshoot current value Iw/OVS, and vice versa.

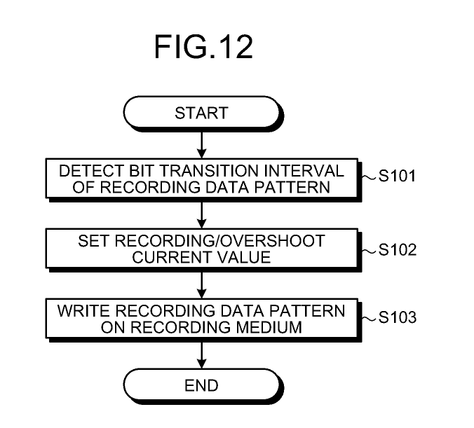

How to set the recording current, which has been mentioned previously, will be described with reference to a flowchart depicted in FIG. 12.

At Step S101, the recording-current setting circuit 28 detects the bit transition interval of the recording data pattern modulated by the data modulating circuit 26 by using the clock signal generated by the clock generating circuit 25. The system control then proceeds to Step S102.

At Step S102, the recording-current setting circuit 28 refers to the reference table, which presents relation between the recording/overshoot current values Iw/OVS and the bit transition intervals as depicted in FIG. 11, and sets the recording/overshoot current value Iw/OVS to a value that corresponds to the detected bit transition interval in the reference table. The recording-current setting circuit 28 sends a control signal that represents the recording/overshoot current value Iw/OVS to the recording-current generating circuit 29. The system control then proceeds to Step S103.

At Step S103, for every magnetization transition that is to occur according to the recording data pattern fed from the recording compensating circuit 27, the recording-current generating circuit 29 generates a recording current of the recording/overshoot current value Iw/OVS having been set by the recording-current setting circuit 28 for writing of the recording data pattern on the recording medium 13. Then, the setting of the recording current is completed. By setting the recording current corresponding to the bit transition interval in this manner, the recording data pattern can be written on the recording medium 13 by applying the electric current of the recording/overshoot current value Iw/OVS that counteracts the side erase effect.

As mentioned previously, the recording/overshoot current value Iw/OVS is set depending on the frequency dependence of the side erase effect. This makes it possible to counteract the side erase effect in a magnetic recording device of any one of two types. In one type of the two types, the magnitude of the side erase effect increases as the recording frequency increases while in the other type, the magnitude of the side erase effect increases as the recording frequency decreases.

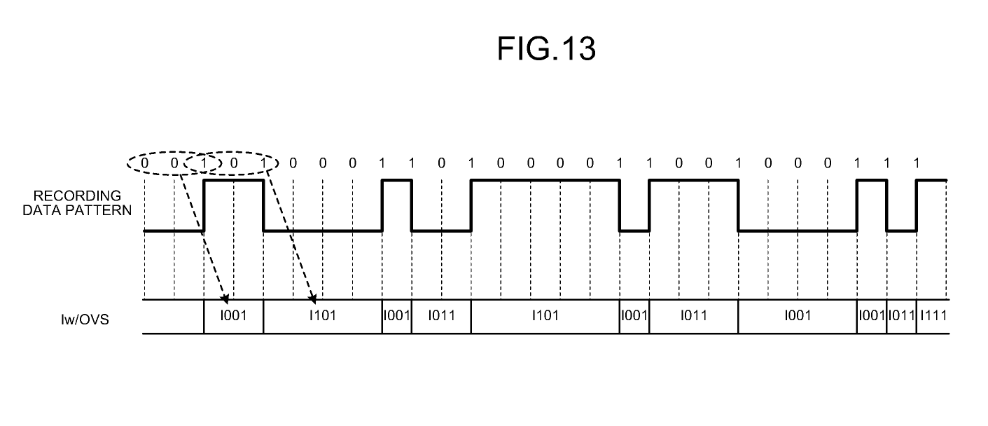

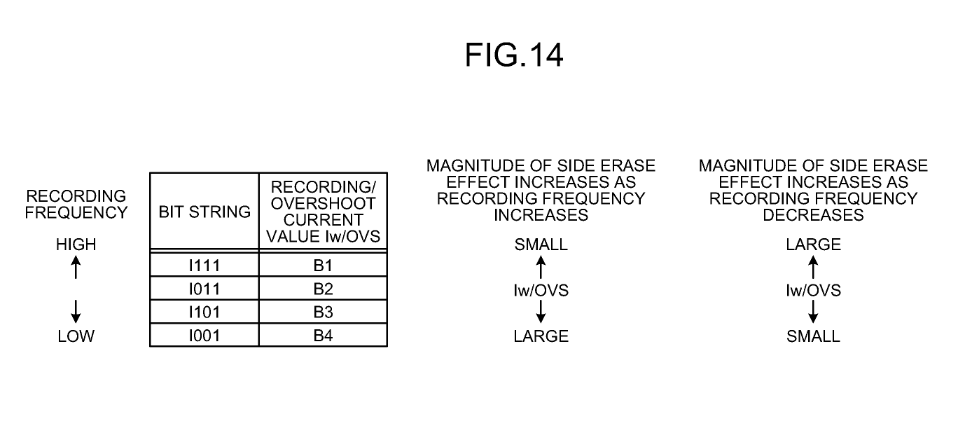

As another example of the method for setting the recording current value, a recording-current setting method based on a bit string of the recording data pattern will be described with reference to FIGS. 13 and 14. The method for setting recording current value based on bit strings, which is performed by the recording-current setting circuit 28, includes detecting a bit string that is constituted of several bits immediately preceding magnetization transition and a bit where the magnetization transition occurs (hereinafter, “bit string immediately preceding magnetization transition”). The recording-current setting circuit 28 sets the recording/overshoot current value Iw/OVS such that the greater the magnitude of the side erase effect that depends on the detected bit string, the lower the recording/overshoot current value Iw/OVS by referring to predetermined data about relation between bit strings and magnitudes of the side erase effect.

FIG. 13 is a schematic chart of an example of the recording data pattern. The sets of reference numerals and symbol I001 to I111 on a bottom portion of FIG. 13 are identification symbols each of which denotes a bit string immediately preceding magnetization transition of the recording data pattern. For example, a bit string immediately preceding a portion in the recording data pattern in which two 0s are followed by one 1 in a dotted ellipse in FIG. 13 is denoted as I001. Another bit string of a portion in the recording data pattern in which bits are arranged in the order of “1, 0, 1” is denoted as I101. The recording-current setting circuit 28 detects the bit string immediately preceding bit transition interval by using the clock signal generated by the clock generating circuit 25. In the present embodiment, the bit string immediately preceding magnetization transition are three bits (two bits immediately preceding magnetization transition and one bit where the magnetization transition occurs); however, the number of bits constituting the bit string is not limited to three. As a matter of course, the bit string can include an arbitrary number of bits.

The recording-current setting circuit 28 refers to a reference table that presents relation between recording/overshoot current values Iw/OVS and bit strings, and sets the recording/overshoot current value Iw/OVS to a value that corresponds to the detected bit string in the reference table. FIG. 14 is an example of the reference table of the relation between the recording/overshoot current values Iw/OVS and the bit strings. In FIG. 14, B1, B2, B3, and B4 are set as the recording/overshoot current values Iw/OVS that correspond to the bit strings of I001, I011, I101, and I111, respectively. According to this reference table, for example, when I001 is detected as the bit string, the recording-current setting circuit 28 sets the recording/overshoot current value Iw/OVS to B1.

If it is desired to determine B1 to B4 accurately, the magnitude of the side erase effect of each of the bit strings can be determined by performing experiments or the like. For example, B1 to B4 can be set by experimentally determining relation between the bit strings and the side erase amounts, relation between the bit strings and the erase widths, or the like.

However, it is also possible to estimate B1 to B4 based on the frequency dependence of the side erase effect that has been mentioned previously rather than performing an experiment. For example, the longer a string of is in a bit string, the shorter the bit transition interval. Hence, when a bit string includes a relatively long string of 1s, it is estimated that the recording frequency for the bit string is relatively high. In contrast, the longer a string of 0s in a bit string, the longer the bit transition interval. Hence, when a bit string includes a relatively long string of 0s, it is estimated that the recording frequency for the bit string is relatively low. Based on this estimation, the recording frequencies for the bit strings I001, I101, I011, and I111 are estimated to be in an ascending order as indicted in FIG. 14.

Accordingly, when the side erase effect exhibits such a frequency dependence that the magnitude of the side erase effect increases as the recording frequency increases, it is assumed that the magnitudes of the side erase effect associated with the bit strings I001, I101, I011, and I111 are in an ascending order. Hence, in this case, the recording/overshoot current values Iw/OVS are set to satisfy B4>B3>B2>B1.

In contrast, when the side erase effect exhibits such a frequency dependence that the magnitude of the side erase effect increases as the recording frequency decreases, it is assumed that the magnitudes of the side erase effect associated with the bit strings I001, I101, I011, and I111 are in a descending order. Hence, in this case, the recording/overshoot current values Iw/OVS are set to satisfy B1>B2>B3>B4.

Put another way, the recording-current setting circuit 28 sets the recording/overshoot current value Iw/OVS such that the greater the magnitude of the side erase effect that depends on the bit string, the lower the recording/overshoot current value Iw/OVS, and vice versa. By setting the recording current in this manner, the recording data can be written on the recording medium 13 by applying an electric current of the recording/overshoot current value Iw/OVS that can counteract the side erase effect as in the case in which the method based on the bit transition interval is employed.

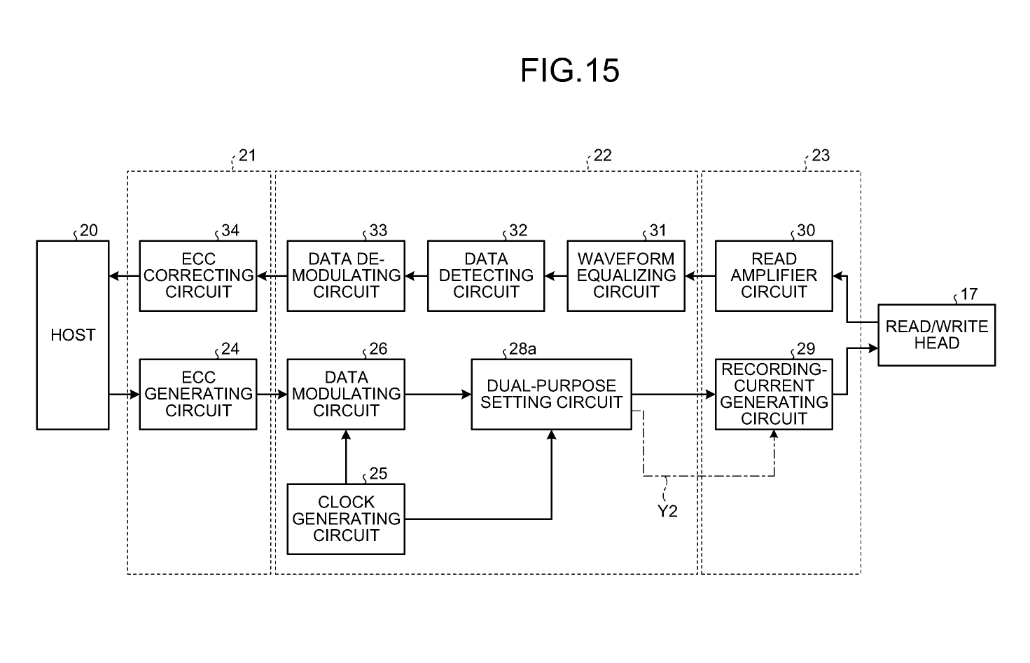

When the recording current value is set based on a bit string in this manner, it is easy to cause a single circuit to provide two functions that are provided by the recording compensating circuit and the recording current setting circuit in the configuration mentioned previously. The example configuration of a magnetic recording device depicted in FIG. 15 differs from the configuration depicted in FIG. 3 in including a dual-purpose setting circuit 28a in place of the recording compensating circuit 27 and the recording-current setting circuit 28 that are independent from each other. The dual-purpose setting circuit 28a has the function of the recording compensating circuit as well as the function of the recording-current setting circuit. The dual-purpose setting circuit 28a not only performs the NLTS compensation but also sets the recording/overshoot current value Iw/OVS and transmits a control signal that represents the recording/overshoot current value Iw/OVS to the recording-current generating circuit 29 as indicated by an alternate long and short dash line arrow Y2 in FIG. 15.

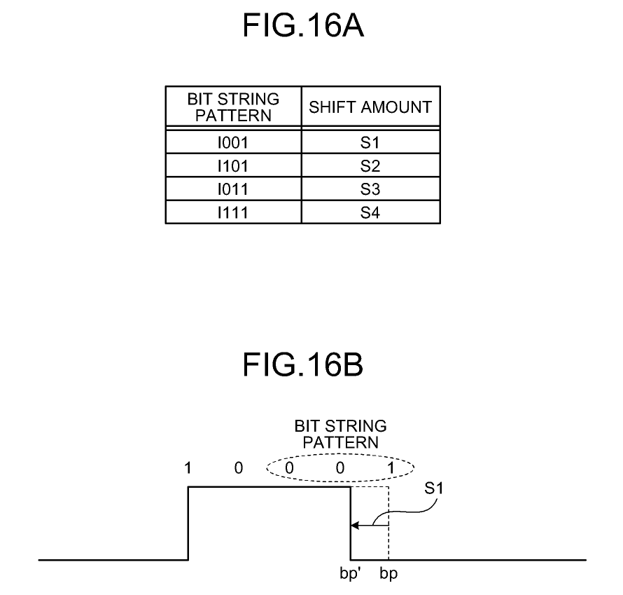

Specific system control to be performed by the dual-purpose setting circuit 28a will be described in detail with reference to FIGS. 16A to 18.

As a comparative example, how the recording compensating circuit 27 performs the NLTS compensation, which has been mentioned previously, will be described in detail. As mentioned previously, the recording compensating circuit 27 performs the NLTS compensation by shifting a magnetization transition position of a recording data pattern forward in advance so that a bit length along the recording track is reduced.

The method for compensating the NLTS will be described with reference to FIGS. 16A and 16B by taking a case, in which NLTS is assumed to be affected by magnetization transition that has previously occurred on three bits, as an example. FIG. 16A is an example of a reference table to be referred to by the recording compensating circuit 27. FIG. 16B is a schematic view of an example in which a bit transition interval is shifted by the NLTS compensation.

The recording compensating circuit 27 detects a bit string immediately preceding magnetization transition of a recording data pattern. The recording compensating circuit 27 refers to the reference table depicted in FIG. 16A to set a shift amount for the magnetization transition position to a value that corresponds to the detected bit string in the reference table, and shifts the magnetization transition position by the thus-set shift amount. For example, when a bit string I001 is detected at a magnetization transition position by as depicted in FIG. 16B, the recording compensating circuit 27 sets the shift amount to S1, and shifts the magnetization transition position by the shift amount S1, thereby advancing the transition position from by to bp′.

Meanwhile, advancing the magnetization transition position in this manner shortens the bit transition interval in polarity. When the bit transition interval is shortened, the amplitude of the recording current can be decreased due to characteristics of an electrical line such as the FPC that connects the preamplifier circuit 23 with the read/write head 17, which can result in a decrease in intensity of the recording magnetic field. The intensity of the magnetic recoding field can also decrease depending on a response speed of a write element. Accordingly, the recording/overshoot current value Iw/OVS is preferably set such that the greater the NLTS of a target bit string, the higher the recording/overshoot current value Iw/OVS (while taking an influence on side erasing into consideration).

In view of the circumstance, the dual-purpose setting circuit 28a not only sets a shift amount for a magnetization transition position to a value that corresponds to the detected bit string but also sets the recording/overshoot current value Iw/OVS to a value that corresponds to the bit string.

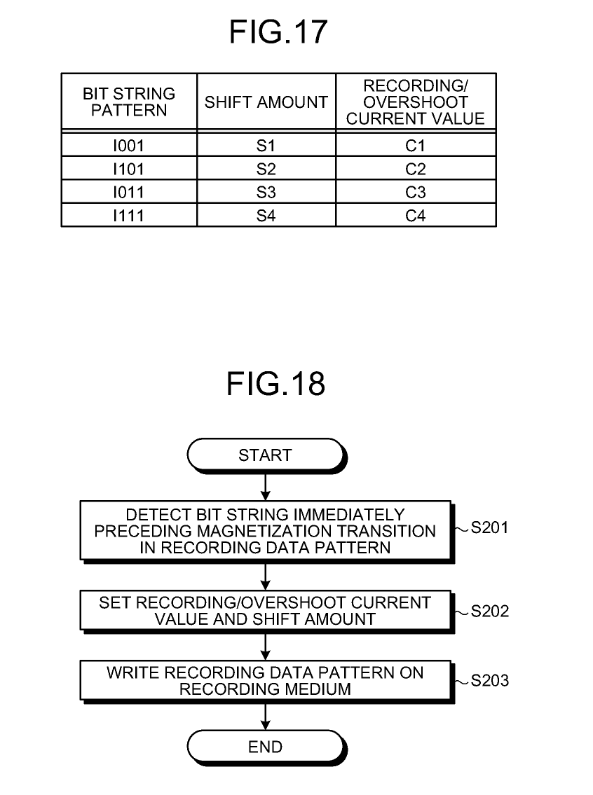

FIG. 17 is an example of a reference table to be referred to by the dual-purpose setting circuit 28a. The reference table presents relation among the recording/overshoot current values Iw/OVS, shift amounts, and the bit strings. For example, upon detecting “I001” as the bit string at a magnetization transition position, the dual-purpose setting circuit 28a sets the shift amount to “S1” and shifts the transition position by the shift amount S1, the dual-purpose setting circuit 28a also sets the recording/overshoot current value Iw/OVS to “C1”.

Note that C1 to C4 are determined based on both the magnitudes of side erase effect and degrees of decrease in amplitude of the recording current. More specifically, C1 to C4 are set to such values with which the side erase effect and decrease in amplitude of the recording current that results from the recording compensation can be suppressed. For example, the recording/overshoot current value Iw/OVS is set such that the recording/overshoot current value Iw/OVS decreases as the magnitude of the side erase effect that depends on a bit string increases and the NLTS that depends on the bit string decreases.

As is obvious from the previous description, the bit string immediately preceding magnetization transition is utilized also in the NLTS compensation. Hence, when the recording current is to be set based on a bit string, the reference table can be readily used in a shared manner. By using the reference table in a shared manner, suppression of the side erase effect and the NLTS compensation can be performed concurrently, which leads to power saving and downsizing of circuit.

How the dual-purpose setting circuit 28a sets the recording current will be described with reference to a flowchart depicted in FIG. 18.

At Step S201, the dual-purpose setting circuit 28a detects a bit string immediately preceding magnetization transition in a recording data pattern modulated by the data modulating circuit 26 by using a clock signal generated by the clock generating circuit 25. The system control then proceeds to Step S202.

At Step S202, the dual-purpose setting circuit 28a refers to a reference table that presents relation among bit strings, shift amounts, and recording/overshoot current values Iw/OVS, and sets a shift amount to a value that corresponds to the detected bit string in the reference table. An example of the reference table is presented in FIG. 17. The dual-purpose setting circuit 28a also sets the recording/overshoot current value Iw/OVS by referring to the reference table. The dual-purpose setting circuit 28a shifts a magnetization transition position by the thus-determined shift amount while the dual-purpose setting circuit 28a transmits a control signal that represents the recording/overshoot current value Iw/OVS to the recording-current generating circuit 29. The system control then proceeds to Step S203.

At Step S203, for every magnetization transition according to the recording data pattern fed from the dual-purpose setting circuit 28a, the recording-current generating circuit 29 generates a recording current of the recording/overshoot current value Iw/OVS that is set based on the bit string immediately preceding the magnetization transition by referring to the reference table. The recording data pattern is written on the recording medium 13. Then, the setting of the recording current is completed. By setting the recording current in this manner, the recording data pattern can be written as well on the recording medium 13 by applying the electric current of the recording/overshoot current value Iw/OVS with which the side erase effect can be suppressed.

A selection as to which one of the method for setting the recording current value based on a bit transition interval and the method for setting the same based on a bit string is to be employed will be described. When it is desired to counteract the side erase effect effectively by establishing accurate correspondence with a recording frequency, the method for setting the recording current value based on a bit transition interval that is in accurate relationship with the recording frequency is preferably employed. When it is desired for the magnetic recording device to reduce power consumption and use a smaller circuit, the method by using the dual-purpose setting circuit 28a to determine the recording current based on a bit string is preferably employed.

Meanwhile, both the method for setting the recording current value based on the bit transition interval and the method for setting the same based on a bit string can be employed. For example, a configuration in which the recording-current setting circuit 28 determines an approximate value (e.g., the recording current value Iw) of the recording current based on the bit transition interval and also performs fine adjustment of the recording current (e.g., the overshoot current value OVS) based on a bit string can be employed.

In the present embodiment, the recording-current setting circuit 28 determines the recording/overshoot current value Iw/OVS based on the bit transition interval (or the bit string) of the recording data pattern by referring to the reference table. However, the method for determining the recording/overshoot current value Iw/OVS is not limited thereto. As a matter of course, the recording/overshoot current value Iw/OVS can be alternatively determined by using a relational expression that represents relation between the bit transition interval (or the bit string) and the recording/overshoot current value Iw/OVS rather than by using the previously-mentioned method. The relational expression can be calculated in advance based on, e.g., the frequency dependence of the side erase effect.

According to the embodiments, a magnetic recording device includes a setting circuit. The setting circuit is, for example, a recording-current setting circuit capable of setting any one of a recording current value and an overshoot current value of a recording electric current (hereinafter, “recording/overshoot current value”). The setting circuit sets the recording/overshoot current value by referring to predetermined data about relation between a magnitude of side erase effect on a track adjacent to a recording track and a recording data pattern. The setting circuit sets the recording/overshoot current value such that the greater the magnitude of the side erase effect associated with the recording data pattern, the lower the recording/overshoot current value. The recording-current generating circuit generates a recording current of the recording/overshoot current value set by the setting circuit. A write head supplied with the recording current writes the recording data pattern on the perpendicular magnetic recording medium.

According to the embodiments, a magnetic recording method includes steps of setting and generating a recording electric current that is to be supplied to a write head for writing of a recording data pattern on a perpendicular magnetic recording medium. The step of setting sets at least one of a recording current value and an overshoot current value (hereinafter, “recording/overshoot current value”) such that the greater a magnitude of side erase effect associated with the recording data pattern, the lower the recording/overshoot current value by referring to predetermined data about relation between a magnitude of side erase effect on a track adjacent to a recording track and the recording data pattern. The step of generating generates a recording electric current of the recording/overshoot current value set at the setting. The write head supplied with the recording current writes the recording data pattern on the perpendicular magnetic recording medium.

According to the embodiments, a recording-current generating circuit sets a recording/overshoot current value such that the greater the magnitude of side erase effect on adjacent tracks, the lower the recording/overshoot current value. Accordingly, the magnitude of the side erase effect on the adjacent tracks can be reduced while maintaining favorable read/write characteristics remained as compared with an approach that adjusts the recording/overshoot current value Iw/OVS according to only the recording frequency. Hence, high-density recording can be attained.

According to the embodiments, a magnetic recording method can yield a similar effect to that yielded by the above recording-current generating circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic recording device comprising:
a write head;
a perpendicular magnetic recording medium that includes a plurality of tracks, the tracks including a recording track;
a recording-current generating circuit that generates a recording electric current that is to be supplied to the write head for writing of a recording data pattern on the recording track of the perpendicular magnetic recording medium; and
a setting circuit that sets a value of the recording electric current such that the value of the recording electric current decreases as magnitude of side erase effect on one track of the tracks other than the recording track increases, the side erase effect being caused by the writing of the recording data pattern on the recording track.

2. The magnetic recording device according to claim 1, wherein the setting circuit sets the value of the recording electric current depending on a property of the side erase effect as to how a side erase amount, which is an amount of data to be erased by the side erase effect, of the one track changes in response to a change in a recording frequency.

3. The magnetic recording device according to claim 1, wherein the setting circuit sets the value of the recording electric current depending on a property of the side erase effect as to how an erase width, which is a width in a track width direction of an area to be erased by the side erase effect, changes in response to a change in a recording frequency.

4. The magnetic recording device according to claim 1, wherein the setting circuit detects a bit transition interval of the recording data pattern, and sets the value of the recording electric current to a value that corresponds to the bit transition interval detected by the setting circuit by referring to predetermined data about relation between bit transition intervals and magnitudes of the side erase effect.

5. The magnetic recording device according to claim 4, wherein the setting circuit sets the value of the recording electric current such that the value of the recording electric current decreases as the magnitude of the side erase effect that depends on the bit transition interval increases while the setting circuit sets the value of the recording electric current such that the value of the recording electric current increases as the magnitude of the side erase effect that depends on the bit transition interval decreases.

6. The magnetic recording device according to claim 1, wherein the setting circuit detects a bit string immediately preceding magnetization transition in the recording data pattern, and sets the value of the recording electric current to a value that corresponds to the bit string detected by the setting circuit by referring to predetermined data about relation between bit strings and magnitudes of the side erase effect.

7. The magnetic recording device according to claim 6, wherein the setting circuit sets the value of the recording electric current such that the value of the recording electric current decreases as the magnitude of the side erase effect that depends on the bit string increases while the setting circuit sets the value of the recording electric current such that the value of the recording electric current increases as the magnitude of the side erase effect associated with the bit string decreases.

8. The magnetic recording device according to claim 6, wherein
the setting circuit has a function of shifting a magnetization transition position in a recording data pattern, thereby compensating shifting of the magnetization transition position, the shifting being to occur when the recording data pattern is written on the perpendicular magnetic recording medium, and
the setting circuit shifts the magnetization transition position by a shift amount that corresponds to the bit string detected by the setting circuit by referring to predetermined data about relation among bit strings, magnitudes of the side erase effect, and shift amounts while the setting circuit sets the recording current value.

9. The magnetic recording device according to claim 1, further comprising a recording compensating circuit that shifts a magnetization transition position in the recording data pattern, thereby compensating shifting of the magnetization transition position, the shifting being to occur when the recording data pattern is written, wherein the recording compensating circuit compensates the shifting of the magnetization transition position in the recording data pattern for which the recording current value has been set by the setting circuit.

10. The magnetic recording device according to claim 1, further comprising a data modulating circuit that performs data modulation of the recording data pattern, wherein the setting circuit sets the recording current value based on the recording data pattern having been modulated by the recording modulating circuit.

11. A recording control circuit comprising:
a recording-current generating circuit that generates a recording electric current that is to be supplied to a write head for writing of a recording data pattern on a recording track of a perpendicular magnetic recording medium that includes a plurality of tracks, the tracks including the recording track; and
a setting circuit that sets a value of the recording electric current such that the value of the recording electric current decreases as magnitude of side erase effect on one track of the tracks other than the recording track increases, the side erase effect being caused by the writing of the recording data pattern on the recording track.

12. An magnetic recording method for use in a magnetic recording device that includes a write head and a perpendicular magnetic recording medium that includes a plurality of tracks, the tracks including a recording track, the electrical recording method comprising:
generating a recording electric current that is to be supplied to the write head for writing of a recording data pattern on the recording track of the perpendicular magnetic recording medium; and
setting a value of the recording electric current such that the value of the recording electric current decreases as magnitude of side erase effect on one track of the tracks other than the recording track increases, the side erase effect being caused by the writing of the recording data pattern on the recording track.
